(19) United States
(12) Patent Application Publication
(10) Pub. No.: US 2004/0096621 A1
(43) Pub. Date: May 20, 2004

(54) High denier textured polypropylene fibers and yarns

(76) Inventors: Weihua Sonya Dai, Spartanburg, SC (US); Brian G. Morin, Greer, SC (US)

Correspondence Address: Milliken & Company, P. O. Box 1927, Spartanburg, SC, 29304, US

(21) Appl. No.: 10/295,747

(22) Filed: Nov. 17, 2002

(51) Int. Cl. B32B 33/00; D01D 5/22; D02G 3/02

(52) U.S. Cl. 428/97; 428/369; 428/394; 57/246; 264/168

(57) ABSTRACT

Improvements in creating resilient high denier polypropylene yarns are provided. Generally, high denier polypropylene yarns exhibit poor resiliency (such as crush resistance, for example, when utilized as carpet face yarns) that effectively prevents widespread use in articles that require high degrees of resiliency. As a result, higher cost, but more resilient, yarns, such as polyesters or polyamides, have found greater acceptance in such end-use articles. Furthermore, previous attempts at texturing high denier polypropylene fibers have failed to attain suitable resilience levels therein is insufficient to permit proper return to initial shape and/or length after impact. It has now surprisingly been determined that such high denier polypropylene yarns can be produced with certain nucleating additives that permit requisite degrees of shape and length retention, and thus acceptable resilience levels to permit cost-effective replacement of more expensive polyester or polyamide yarns in certain end-use applications.

### FIELD OF THE INVENTION

This invention relates to improvements in creating resilient high denier polypropylene yarns. Generally, high denier polypropylene yarns exhibit poor resiliency (such as crush resistance, for example, when utilized as carpet face yarns) that effectively prevents widespread use in articles that require high degrees of resiliency. As a result, higher cost, but more resilient, yarns, such as polyesters or polyamides, have found greater acceptance in such end-use articles. Furthermore, previous attempts at texturing high denier polypropylene fibers have failed to attain suitable resilience levels therein is insufficient to permit proper return to initial shape and/or length after impact. It has now surprisingly been determined that such high denier polypropylene yarns can be produced with certain nucleating additives that permit requisite degrees of shape and length retention, and thus acceptable resilience levels to permit cost-effective replacement of more expensive polyester or polyamide yarns in certain end-use applications.

### DISCUSSION OF THE PRIOR ART

There has been a continued desire to utilize high denier textured polypropylene fibers in various different products, ranging from apparel to carpet backings (as well as carpet pile fabrics) to reinforcement fabrics, and so on. Textured polypropylene fibers theoretically, at least, should exhibit standard polypropylene properties, such as excellent strength characteristics, highly desirable hand and feel, and protection from degradation or erosion when exposed to certain “destructive” chemicals. However, even with such impressive and beneficial properties and an abundance of polypropylene, which is relatively inexpensive to manufacture and readily available as a petroleum refinery byproduct, such textured fibers are not widely utilized in products that require high degrees of fiber and/or yarn resilience for aesthetic and/or performance issues. Without intending to be bound to any specific scientific theory, it is believed that this lack of sufficient resiliency levels is due to the failure of polypropylene crystal structures to retain a desired orientation after impact forces are applied thereto. As such, the fibers and/or yams are generally easily manipulated to undesirable disparate shapes and/or lengths after exposure to such forces (e.g., pedestrians traversing carpet with polypropylene face yarns, resulting in crushing without sufficient return to initial shape). AS noted above, although polyesters (such as polyethylene terephthalate, or PET) and polyamides (such as nylons) are generally more expensive to manufacture, such fibers do not exhibit the same unacceptable low resiliency problems as polypropylenes. Thus, it is imperative to provide remedies to such issues to permit utilization of such lower cost polymer materials in greater varieties of end-uses. Such a need has heretofore gone unattained.

In particular, these poor resilience results appear to be the result of a lack of effective texturing or twisting capabilities for high denier polypropylene fibers and/or yarns. Texturing generally involves a manipulation of the entire fiber or yarn into a set shape through such processes as crimping, twisting, and the like, with the ultimate yarn heat-set to at least initially exhibit the textured configuration applied thereto. Unfortunately, as noted above, polypropylene is susceptible to crystal orientation modifications through exposure to external forces that exceed the crystal-lattice strengths thereby causing a loss in crystal orientation without a suitable capability of returning to the previous configuration thereafter. Thereby, the polypropylene yarn loses its texture or twist or bulk and complies to the external force. Also, as noted above, this problem has not been exacerbated through the utilization of standard polypropylene additives, such as nucleating agents (sodium benzoate, most prominently). Hence, it is imperative that if less expensive polypropylene yarns are to supplant more expensive polyester and polyamide yarns in resilience-required end-use applications, then a manner of permitting texturing or twisting of such polypropylene yarns that permits crystal orientation retention after impact forces have been applied (e.g., a manner of supplying greater crystal-lattice strength for shape and/or length retention in excess of usual impact forces applied thereto) is necessary. However, to date, no solution to this problem has been offered to the pertinent resilient yarn markets.

### DESCRIPTION OF THE INVENTION

It is thus an object of the invention to provide more reliable texturing methods that produce resilient polypropylene yarns. A further object of the invention is to provide a class of additives that, in a range of concentrations, will permit such resiliency improvements in high denier polypropylene yarns. A further object of the invention is to provide a preferred class of additives that, in a range of concentrations, will permit superior texture retention and resilience for textured yarns, where the texturing process requires heating the yarn above 100° C. A further object of the invention is to provide a specific method for the production of nucleator-containing high denier polypropylene fibers that can be reliably textured to impart sufficient resilience thereto.

Accordingly, this invention encompasses a method of producing polypropylene fibers exhibiting deniers per yarn in excess of 1000, comprising the sequential steps of a) providing a polypropylene composition in pellet or liquid form comprising at least 100 ppm by weight of a nucleator compound which imparts a crystallization temperature to polypropylene homopolymer of at least 118° C.; b) melting and mixing said polypropylene composition of step “a” to form a substantially homogeneous molten plastic formulation; c) extruding said plastic formulation to form a fiber structure; d) texturing said extruded fiber of step “c”; and e) spinning said extruded, textured fiber (optionally while exposing said fiber to a temperature of at most 105° C.). Also encompassed within this invention is polypropylene yarn comprising at least 100 ppm of a nucleating agent, said yarn having been textured using a process that involves heating the fiber above 100° C., as well as carpet manufactured therewith. Also included in this invention is a polypropylene yarn comprising at least 100 ppm of a nucleating agent which imparts a crystallization temperature within polypropylene homopolymer of at least 118, preferably at least 120° C., wherein said yarn is textured using a process that requires heat. Such processes are well known and include false twist texturing, bulked continuous filament (BCF) texturing, stuffer box texturing, gear crimp texturing, and the like. Such a procedure may be accomplished with any number of apparatus, including, without limitation, godet rolls, nip rolls, steam cans, hot or cold gaseous jets (air or steam), and other like mechanical means, as well as any texturing means, such as a crimper, twister, and the like.

Such fibers (or yarns comprising such fibers) require the presence of certain compounds that quickly and effectively provide the necessary crystal orientations and crystal-lattice strengths to overcome any impact forces applied thereto up to about 1600 psi, for example. Furthermore, such an additive basically permits the yams to be flexed, bent, and otherwise temporarily manipulated without breakage within the target article; however, it is the ability of such an additive to create a crystal orientation that is retained after such temporary manipulation that is so surprising and unexpected for this invention. The nucleating compounds must nucleate polymer crystals at a higher temperature than the target polypropylene without the nucleating agent during cooling. In such a manner, the nucleator compounds provide nucleation sites for polypropylene crystal growth which, in turn, appear to provide thick lamellae within the fibers themselves which, apparently (without intending on being bound to any specific scientific theory) can be textured during yarn production and easily set in a desired configuration. The preferred nucleating compounds include dibenzylidene sorbitol based compounds, as well as less preferred compounds, such as sodium and lithium phosphate salts (such as sodium 2,2′-methylene-bis-(4,6-di-tert-butylphenyl)phosphate, otherwise known as NA-11 and NA-21). Generally, sodium benzoate is to be avoided for this procedure as the crystallization temperatures imparted to polypropylene, in particularly homopolymer polypropylene, is too low for proper heat-setting and thus resiliency (below 118° C.).

The amount of nucleating agent present within the inventive fiber is at least 100 ppm; preferably this amount is at least 1000 ppm; and most preferably is at least 1250 ppm. Any amount of such a nucleating agent should suffice to provide the desired fiber properties after heat-setting of the fiber itself; however, excessive amounts (e.g., above about 10,000 ppm and even as low as about 6,000 ppm) should be avoided, primarily due to costs, but also due to potential processing problems with greater amounts of additives present within the target fibers.

The target fibers and/or yarns are thus textured in any manner commonly followed for polypropylene materials. Such texturing methods include, without limitation processes in which the fiber is deformed, and then heated and cooled in this deformed state. One example of this is false twist texturing, in which a twist is imparted to the fiber through the use of spindles, and while the fiber is in the twisted state it is heated and then cooled to impart into the individual filaments a memory of the twisted state. The yarn is then untwisted, but retains bulk due to the imparted memory. In another texturing embodiment, known as bulked continuous filament (BCF), the yarn is pushed with air jets into a stuffer box where it is crowded in a non-uniform state with other fibers and heated to retain the memory of this non-uniform state. The yarn is then cooled, but again retains bulk due to the imparted memory. Of course, other texturing methods, such as air texturing, gear texturing, etc., may be used. Polypropylene polymer containing nucleators retains the imparted memory of these texturing techniques better than polymer without nucleators because of the increased crystallization rate that the polypropylene undergoes when at elevated temperatures. Preferred are nucleators which nucleate the fiber at a higher temperature, preferably over about 118 C, more preferably over about 120 C, when measured on a DSC at 20 C/min.

The term “polypropylene” is intended to encompass any polymeric composition comprising propylene monomers, either alone or in mixture or copolymer with other randomly selected and oriented polyolefins, dienes, or other monomers (such as ethylene, butylene, and the like). Such a term also encompasses any different configuration and arrangement of the constituent monomers (such as syndiotactic, isotactic, and the like). Thus, the term as applied to fibers is intended to encompass actual long strands, tapes, threads, and the like, of drawn polymer. The polypropylene may be of any standard melt flow (by testing); however, standard fiber grade polypropylene resins possess ranges of Melt Flow Indices between about 2 and 50. Contrary to standard plaques, containers, sheets, and the like (such as taught within U.S. Pat. No. 4,016,118 to Hamada et al., for example), fibers clearly differ in structure since they must exhibit a length that far exceeds its cross-sectional area (such, for example, its diameter for round fibers). Fibers are extruded and drawn; articles are blow-molded or injection molded, to name two alternative production methods. Also, the crystalline morphology of polypropylene within fibers is different than that of standard articles, plaques, sheets, and the like. For instance, the dpf of such polypropylene fibers is at most about 5000; whereas the dpf of these other articles is much greater. Polypropylene articles generally exhibit spherulitic crystals while fibers exhibit elongated, extended crystal structures. Thus, there is a great difference in structure between fibers and polypropylene articles such that any predictions made for spherulitic particles (crystals) of nucleated polypropylene do not provide any basis for determining the effectiveness of such nucleators as additives within polypropylene fibers.

The terms “nucleators”, “nucleator compound(s)”, “nucleating agent”, and “nucleating agents” are intended to generally encompass, singularly or in combination, any additive to polypropylene that produces nucleation sites for polypropylene crystals from transition from its molten state to a solid, cooled structure. Hence, since the polypropylene composition (including nucleator compounds) must be molten to eventually extrude the fiber itself, the nucleator compound will provide such nucleation sites upon cooling of the polypropylene from its molten state. The only way in which such compounds provide the necessary nucleation sites is if such sites form prior to polypropylene recrystallization itself. Thus, any compound that exhibits such a beneficial effect and property is included within this definition. Such nucleator compounds more specifically include dibenzylidene sorbitol types, including, without limitation, dibenzylidene sorbitol (DBS), monomethyldibenzylidene sorbitol, such as 1,3:2,4-bis(p-methylbenzylidene) sorbitol (p-MDBS), dimethyl dibenzylidene sorbitol, such as 1,3:2,4-bis(3,4-dimethylbenzylidene) sorbitol (3,4-DMDBS); other compounds of this type include, again, without limitation, NA-11, and other like compounds. The concentration of such nucleating agents (in total) within the target polypropylene fiber is at least 100 ppm, preferably at least 1250 ppm. Thus, from about 100 to about 5000 ppm, preferably from about 500 ppm to about 4000 ppm, more preferably from about 1000 ppm to about 3500 ppm, still more preferably from about 1500 ppm to about 3000 ppm, even more preferably from about 2000 ppm to about 3000 ppm, and most preferably from about 2500 to about 3000 ppm. Again, sodium benzoate is specifically insufficient in performance within this invention, and thus the nucleator compound may be generally be defined as any compound other than sodium benzoate.

Also, without being limited by any specific scientific theory, it appears that the required nucleators which perform the best are those which exhibit relatively high solubility within the propylene itself. Thus, compounds which are readily soluble, such as 1,3:2,4-bis(p-methylbenzylidene) sorbitol provides the lowest shrinkage rate and highest resilience for the desired polypropylene fibers. The DBS derivative compounds are considered the best shrink-reducing and resiliency improving nucleators within this invention due to the low crystalline sizes produced by such compounds. Other nucleators, such as NA-11, also impart acceptable characteristics to the target polypropylene fiber in terms of withstanding high speed spinning tensions; however, apparently due to poor dispersion of NA-11 in polypropylene and the large and varied crystal sizes of NA-11 within the fiber itself, the resilience levels are noticeably lower than for the highly soluble, low crystal-size polypropylene produced by well-dispersed MDBS or, preferably, 3,4-DMDBS.

It has been determined that the nucleator compounds that exhibit good solubility in the target molten polypropylene resins (and thus are liquid in nature during that stage in the fiber-production process) provide more effective resiliency properties, as well as other potential beneficial characteristics, such as low-shrink, high tensile strength, etc., properties. Thus, substituted DBS compounds (including DBS, p-MDBS, and, preferably 3,4-DMDBS) appear to provide fewer manufacturing issues as well as lower shrink properties within the finished polypropylene fibers themselves. Although 3,4-DMDBS is preferred for such high denier fibers, any of the above-mentioned nucleators may be utilized within this invention. Mixtures of such nucleators may also be used during processing in order to provide such desirable high resiliency measurements, as well as possible organoleptic improvements, facilitation of processing, or cost.

In addition to those compounds noted above, NA-11 is well known as a nucleating agent for standard polypropylene compositions (such as the aforementioned plaques, containers, films, sheets, and the like) and exhibit excellent recrystallization temperatures and very quick injection molding cycle times for those purposes. The dibenzylidene sorbitol types exhibit the same types of properties as well as excellent clarity within such standard polypropylene forms (plaques, sheets, etc.). For the purposes of this invention, it has been found that the dibenzylidene sorbitol types are preferred as nucleator compounds within the target polypropylene fibers.

The closest prior art references teach the addition of nucleator compounds to general polypropylene compositions (such as in U.S. Pat. No. 4,016,118, referenced above). However, some teachings include the utilization of certain DBS compounds within limited portions of fibers in a multicomponent polypropylene textile structure. For example, U.S. Pat. Nos. 5,798,167 to Connor et al. and 5,811,045 to Pike, both teach the addition of DBS compounds to polypropylene in fiber form; however, there are vital differences between those disclosures and the present invention. For example, both patents require the aforementioned multicomponent structures of fibers. Thus, even with DBS compounds in some polypropylene fiber components within each fiber type, the resiliency for each is dominated by the other polypropylene fiber components which do not have the benefit of the nucleating agent. These fibers have not been textured using a heating process, and thus the increases in resiliency associated with using a nucleator during a heated texturing process have not been achieved. Also, there are no thick lamellae that can potentially provide the desired high resiliency levels through strong crystal orientations formed within the disclosed polypropylene fibers. Of further importance is the fact that, for instance, Connor et al. require a nonwoven polypropylene fabric laminate containing a DBS additive situated around a polypropylene internal fabric layer which contained no nucleating agent additive. The internal layer, being polypropylene without the aid of a nucleating agent additive, dictates the resiliency for this structure as well.

In addition, Spruiell, et al, Journal of Applied Polymer Science, Vol. 62, pp. 1965-75(1996), reveal using a nucleating agent, MDBS, at 0.1%, to increase the nucleation rate during spinning. However, after crystallizing and drawing the fiber, Spruiell et al. do not discuss the texturing capabilities nor the resiliency possibilities thereof.

In U.S. Pat. No 6,129,879, to Bersted, et al, high resilience polypropylene fibers are taught. However, they utilize long steam heating times which reduce the strength and modulus of the fiber and cause difficulty in manufacture due to the extended times required. Further, they do not mention the use of a nucleating agent, which greatly reduces processing times, and imparts specific properties to the fibers that they do not achieve.

Furthermore, such fibers may also be colored to provide other aesthetic features for the end user. Thus, the fibers may also comprise coloring agents, such as, for example, pigments, with fixing agents for lightfastness purposes. For this reason, it is desirable to utilize nucleating agents that do not impart visible color or colors to the target fibers. Other additives may also be present, including antistatic agents, brightening compounds, clarifying agents, antioxidants, antimicrobials (preferably silver-based ion-exchange compounds, such as ALPHASAN® antimicrobials available from Milliken & Company), UV stabilizers, fillers, and the like. Furthermore, any fabrics made from such inventive fibers may be, without limitation, woven, knit, non-woven, in-laid scrim, any combination thereof, and the like. Additionally, such fabrics may include fibers other than the inventive polypropylene fibers, including, without limitation, natural fibers, such as cotton, wool, abaca, hemp, ramie, and the like; synthetic fibers, such as polyesters, polyamides, polyaramids, other polyolefins (including non-low-shrink polypropylene), polylactic acids, and the like; inorganic fibers such as glass, boron-containing fibers, and the like; and any blends thereof.

### BRIEF DESCRIPTION OF THE DRAWINGS

The accompanying drawings, which are incorporated in and constitute a part of this specification, illustrate a potentially preferred embodiment of producing the inventive low-shrink polypropylene fibers and together with the description serve to explain the principles of the invention wherein:

FIG. 1 is a schematic of the potentially preferred method of producing high denier polypropylene fibers through high speed spinning machinery.

### DETAILED DESCRIPTION OF THE DRAWING AND OF THE PREFERRED EMBODIMENT

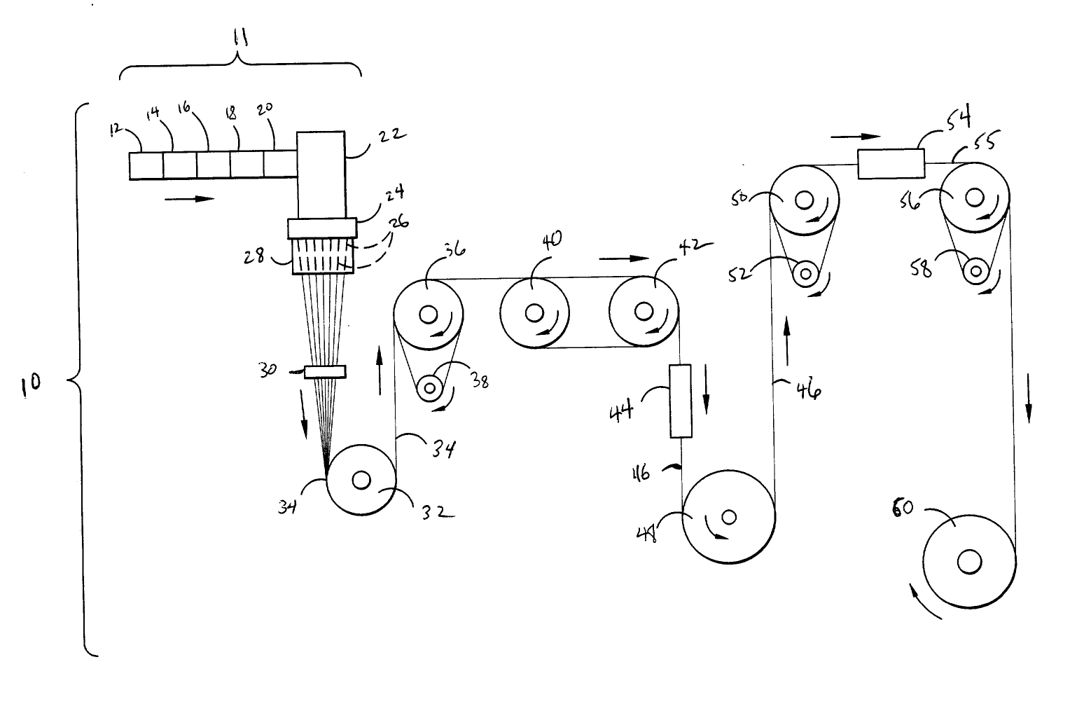

FIG. 1 depicts the non-limiting preferred procedure followed in producing the inventive low-shrink polypropylene fibers. The entire fiber production assembly 10 comprises an extruder 11 comprising five different zones 12, 14, 16, 18, 20 through which the polymer (not illustrated) passes at different, increasing temperatures. The molten polymer is mixed with the nucleator compound (also molten) within a mixer zone 22. Basically, the polymer (not illustrated) is introduced within the fiber production assembly 10, in particular within the extruder 11. The temperatures, as noted above, of the individual extruder zones 12, 14, 16, 18, 20 and the mixing zone 22 are as follows: first extruder zone 12 at 205° C., second extruder zone 14 at 215° C., third extruder zone 16 at 225° C., fourth extruder zone 18 at 235° C., fifth extruder zone 20 at ?, and mixing zone 22 at 245° C. The molten polymer (not illustrated) then moves into a spin head area 24 set at a temperature of 250° C. including a spinneret (not illustrated) (also set at a temperature of 250° C.) for strand extrusion. The fibrous strands 26 then pass through a heated shroud 28 having an exposure temperature of 180° C. The fiber strands move through a finishing area 30 for application of a lubricant (water, oil, and the like), and follow through to a take-up roll 32 where the individual fibers are collected to form a yarn 34. The speed at which the fiber strands 26 and ultimately the collected yarn 34 pass through the extruder 11, spin head area 24, and spinneret (not illustrated) is relatively slow until the fibrous yarn 34 is pulled through by two sets of draw rolls 36, 38, 40, 42. The yarn 34 extends in length due to a greater pulling speed in excess of the initial extrusion speed within the extruder 11 at this point. The yarn 34 then moves through a texturing area 44 that, in the preferred situation, applies a crimplike configuration to the yarn by quickly manipulating the yarn in alternating juxtaposed directions as it moves therethrough. Application of sufficient heat thus heat-sets such a crimped orientation within the crystal components therein and ultimately the textured yarn 46 itself. The textured yarn 46 is then cooled on a drum 48 and collected on a series of take-up rolls 50, 52 prior to moving through an entanglement chamber 54, wherein pneumatic pressures are applied to the textured yarn 46 to create entanglement between the fibers therein to hold the yarns together. Subsequently, the entangled textured yarn 55 is then collected on another series of take-up rolls 56, 58 and moved to a winder 60 and is placed on a spool (not illustrated).

### Inventive Fiber and Yarn Production

The following non-limiting examples are indicative of the preferred embodiment of this invention:

Yarn Production

Fiber was made by compounding Amoco 7550 fiber grade polypropylene resin (melt flow of 18) with a nucleator additive and a standard polymer stabilization package consisting of 500 ppm of Irganox® 1010, 1000 ppm of Irgafos® 168 (both antioxidants available from Ciba), and 800 ppm of calcium stearate. The base mixture was compounded at 2500 ppm in a twin screw extruder (at 220° C. in all zones) and made into pellets. The additive was selected from the group of three polypropylene clarifiers commercially available from Milliken & Company, Millad® 3940 (p-MDBS sorbitol) and Millad® 3988 (3,4-DMDBS).

The pellets were then fed into the extruder on an fiber extrusion line as noted above in FIG. 1. Yarn was spun with the extrusion line conditions shown in Table 1 using a 68 hole spinneret, giving a yarn of nominally 150 denier. For each additive, four yarns were spun with heat-set temperatures of 100°, 110°, 120°, and 130° C. respectively. These temperatures are the set temperatures for the controller for the draw rolls 40, 42. In practice, a variation is found to exist over the surface of the rolls 40, 42, up to as much as 10° C. Pellets with no nucleator additive were used to make control fibers.

The fibers were then combined to form yarns of 1000 denier were made at a line speed of 2800 m/min, with heatset temperature 150° C., and a texturing temperature 165° C. The yarns were twisted and cabled on a Saca Lowell Twisting machine, at 5 twists per inch, with one yarn in the Z direction and one in the S direction cabled together. Yarns were heat set with Superba equipment with a pre-bulk temperature of 190° F. and a heatset temperature of 262° F. These yarns were then tufted into a cut pile carpet with a polypropylene tape backing exhibiting a weight of 40 oz/sq yd, with a standard broadloom carpet backing then adhered thereto.

The carpet yarns were tested (within the carpet article made above) as follows: First, a Taber® 5150 Abraser (Taber Industries Inc., North Tonawanda, N.Y.) was used for chair wheel wear test at 500 and 5000 cycles. A hard wheel H22 was used to conduct the test. A predetermined number of cycles was run with this test for each sample. Then a tensile testing machine manufactured from MTS System Corp (Holly Springs, N.C.) was used to do two cycles of compression tests on the carpet which has been through zero cycles of chair wheel test, 500 cycles, or 5000 cycles of chair wheel test. Height at peak measures the distance that the load cell travels until the load cell encounters a resistance of 300 lbs. This indicates if the carpet face yarns can be pressed down or not after being stepped on—an important measurement of how the pedestrian feels when stepping on a carpet. Compression modulus measures the resistance to the pressure. After many cycles of chair wheel test, if the carpet face yarn is compressed, the modulus increases. If the carpet face yarn recovers after the chair wheel test, the modulus should be similar to “as is sample” which experienced zero cycle of chair wheel test. Height at peak 1 and modulus 1 are the measurement at the first cycle of compression testing, while height at peak 2 and modulus 2 are the measurement at the second cycle of compression testing, respectively. The control was made with no nucleator. The inventive sample included 1500 ppm of 3,4-DMDBS.

TABLE 1
Carpet Pile Compression Testing

| | | Hght at | Modulus | Hght at | Modulus |
|---|---|---|---|---|---|
| Sample | Cycles | Peak 1 | 1 Psi | Peak 2 | 2 Psi |
| Control | 0 Cycles | −0.139 | 2719.064 | −0.142 | 4059.471 |
| 3,4-DMDBS | 0 Cycles | −0.1085 | 3263.106 | −0.1105 | 5245.988 |
| Control | 500 Cycles | −0.054 | 3643.011 | −0.057 | 5161.232 |
| 3,4-DMDBS | 500 Cycles | −0.092 | 3183.6435 | −0.0955 | 4598.6525 |
| Control | 5000 Cycles | −0.036 | 3408.394 | −0.039 | 5176.584 |
| 3,4-DMDBS | 5000 Cycles | −0.0745 | 3557.0425 | −0.0785 | 4934.749 |

Compared with the Control, the inventive yarns thus show a marked improvement in terms of resilience (recovery after compression) and crush resistance (the ability to retain its original shape and physical properties with pressure applied thereto.

Two commercial yarns were also analyzed for certain physical properties to show the current capabilities of standard yarns, one a Nylon 66 from Dupont, the other a Grey polypropylene yarn from Duron. Their properties were found to be as follows:

| | | % | | | 150 C. | Re- |
|---|---|---|---|---|---|---|
| | | Elong. | Fiber | 5% Secant | Hot Air | sil- |
| | | @ Peak | Tenacity | Modulus | Shrinkage | ience |
| Sample | Denier | Load | gf/denier | gf/denier | (%) | (%) |
| Nylon | 1399 | 48.697 | 2.372 | 8.013 | 3.98 | 78 |
| Poly- | 968 | 120.357 | 2.486 | 14.234 | 3.04 | 34 |
| proplene | | | | | | |

There are, of course, many alternative embodiments and modifications of the present invention which are intended to be included within the spirit and scope of the following claims.

What we claim is:

1. A method of producing polypropylene fibers exhibiting deniers per yarn in excess of 1000, comprising the sequential steps of a) providing a polypropylene composition in pellet or liquid form comprising at least 100 ppm by weight of a nucleator compound which imparts a crystallization temperature to polypropylene homopolymer of at least 118° C.; b) melting and mixing said polypropylene composition of step “a” to form a substantially homogeneous molten plastic formulation; c) extruding said plastic formulation to form a fiber structure; d) texturing said extruded fiber of step “c”; and e) spinning said extruded, textured fiber (optionally while exposing said fiber to a temperature of at most 105° C.).

2. A polypropylene yarn comprising at least 100 ppm of a nucleating agent, said yarn having been textured using a process that involves heating the fiber above 100° C.

3. A carpet comprising at least one yarn as defined in claim 2.

4. A polypropylene fiber comprising at least 100 ppm of a nucleating compound which imparts a crystallization temperature to polypropylene homopolymer of at least 118° C., wherein said yarn has been textured using a process requiring heat.

5. A polypropylene fiber according to claim 4 wherein nucleating compound imparts a crystallization temperature of at least 120° C.

6. A polypropylene fiber according to claim 5 wherein said nucleating compound is selected from the group consisting of p-MDBS, 3,4-DMDBS, NA-21, and any mixtures thereof.

7. A polypropylene fiber according to claim 6 wherein said nucleating compound is 3,4-DMDBS.
